(19) United States
(12) Patent Application Publication
(10) Pub. No.: US 2021/0191833 A1
(43) Pub. Date: Jun. 24, 2021

(54) COMPONENT DETECTION AND AWARENESS IN A COMPUTING ENVIRONMENT BY AUTOMATICALLY IDENTIFYING PHYSCIAL COMPONENTS HOUSING THE COMPONENT WITHIN THE COMPUTING ENVIRONMENT

(71) Applicant: VMWARE,INC., Palo Alto, CA (US)

(72) Inventors: Amol Manohar Vaikar, Pune (IN); Avinash Nigam, Pune (IN)

(21) Appl. No.: 16/792,332

(22) Filed: Feb. 17, 2020

(30) Foreign Application Priority Data
Dec. 19, 2019 (IN) 201941052880

(51) Int. Cl. G06F 11/30; G06F 11/14; G06F 9/455

(52) U.S. Cl. CPC G06F 11/301; G06F 11/1484; G06F 2009/45591; G06F 2009/4557; G06F 9/45558

(57) ABSTRACT

A component awareness and proximity detection methodology is disclosed. In a computer-implemented method, components of a computing environment are automatically monitored, and configuration information used to uniquely identify the components and their corresponding physical residence in the computing environment and feature selection and location analysis performed thereon. Provided the feature selection analysis determines that features of the components are well defined and identified, a classification of the features is performed. Based on the classification of features components in the computing environment are selectively located in identifiable hosts is performed.

### RELATED APPLICATIONS

Benefit is claimed under 35 U.S.C. 119(a)-(d) to Foreign Application Serial No. 201941052880 filed in India entitled “IMPROVED COMPONENT DETECTION AND AWARENESS IN A COMPUTING ENVIRONMENT BY AUTOMATICALLY IDENTIFYING PHYSCIAL COMPONENTS HOUSING THE COMPONENT WITHIN THE COMPUTING ENVIRONMENT” on Dec. 19, 2019, by VMWARE, Inc., which is herein incorporated in its entirety by reference for all purposes.

### BACKGROUND ART

In a machine learning environment, feature selection (sometimes referred to as “variable selection”, “attribute selection”, or similar) is a critical part of the machine learning process. Feature selection specifically refers to determining which features are important and, therefore, should be used in the creation and operation of a machine learning model. In the feature selection process, a subset of important and/or relevant features is selected from a larger set of features. The subset of important and/or relevant features are then deemed to be of importance to and are, therefore, used in the construction of the machine learning environment.

In various computing environments, including machine learning environments, it is necessary to provide component identification and awareness in a networking and security for the various components in the computing environment in order to protect against numerous cyber threats. One such security measure is provided by the NSX™ platform 804 of VMware, Inc developed by VMware, Inc. of Palo Alto, Calif. Typically, a system administrator (e.g., an Information Technology (IT) administrator, or the like) registers those machines or components of the computing environment, for which the IT administrator desires protection against cyber threats, with a security system such as the above-mentioned NSX™ platform 804 of VMware, Inc. Conventionally, the IT administrator registers the machines or components by manually defining or listing the components, including virtualized machines or components, within the computing environment that are to be registered with the security system being used. Once the various machines or components (virtual and/or physical) are registered with the identification system, the various machines or components are protected by the identification system. Conversely, machines or components which are not registered with the identification system are not protected by the identification system. It will be understood that due to the number of machines or components typically found in a computing environment (and due to the computational overhead required for the identification system to monitor the registered machines or components) it is only feasibly to register a subset of the machines or components with the computing environment.

VMs and hosts are not rack aware i.e., unless manually tagged in the vCenter, there is currently no information available about which data center rack a particular server is mounted on and hence that information cannot be used to determine whether two VMs with a heavy network communication flow between them are on the same rack (and hence on the same TOR switch) or not, which too affects the network latency for communication happening between the VMs. Furthermore, in conventional implementations as stated above, (in for example, vCenter) require a manual logging of host-to-VM relationships. Due to the dynamic nature of Data centers and the like, manual log records are not always accurate and rapidly become out of date. Further, in an NSX or ML environment, as VMs (or other components) are automatically provisioned and unprovisioned, manual logging is not feasible. With such automated computing resource (e.g., rack) awareness, the present invention is able to effectively route communications, and also reduce or eliminate Elephant hairpins and the like. The present invention will reduce network latency, reduce loads on communication networks, and increase communication and operation efficiency by integrating vRNI with intelligent rack management and also leveraging the blade/chassis information from converged infrastructures, the present invention automatically determines the rack in which a particular host is mounted and correlate the information with the VMs and use it in designing the network topology in the computing environment.

In an NSX or automated ML environment, this invention allows for intelligent communication between components. In one embodiment, kernel-to-kernel communication between co-located/co-hosted VMs, in contrast with conventional methods where communication is first routed through a distantly located network router and then ultimately back to a destination VM even when the source VM and the destination VM have closely located hosts (or even co-hostedby the same machine), allow communications to occur by reducing the number of physical devices the communication is routed through.

It should also be noted that most computing environments, including machine learning environments are not static. That is, various machines or components are constantly being added to, or removed from, the computer environment. As such changes are made to the computing environment, it is frequently necessary to amend or change which of the various machines or components (virtual and/or physical) are registered with the security system. Hence, in conventional approaches, and IT administrator (or similar) is required to at least periodically reassess which machines or components the IT administrator needs to register for protection with the security system. Hence, it is possible that newly added important and/or extremely relevant features of a machine learning environment are not be properly registered for appropriate protection by the security system. It is also possible that machines or components which once warranted protection by the security system, no longer require such security protection.

Thus, conventional approaches for providing network access and security to machines or components of a computing environment, including a machine learning environment, are highly dependent upon the skill and knowledge of a system administrator. Also, conventional approaches for providing security to machines or components of a computing environment, are not acceptable in complex and frequently revised computing environments.

Additionally, many conventional network and security systems require every machine or component within a computing environment be assigned to a particular scope and service group so that the intended states can be derived from the service type. As the size and complexity of computing environments increases, such a requirement may require a high-level system administrator to manually register as many as thousands (or many more) of the machines or components (such as, for example, virtual machines) with the security system. Thus, such conventionally mandated registration of the machines or components is not a trivial job. This burden of manual registration is made even more burdensome considering that the target users of many security systems are often experienced or very high-level personnel such as, for example, Chief Information Security Officers (CISOs) and their teams who already have heavy demands on their time.

Furthermore, even such high-level personnel may not have full knowledge of the network topology of the computing environment or understanding of the functionality of every machine or component within the computing environment. Hence, even when possible, the time and/or person-hours necessary to perform and complete such a conventionally required configuration for a security system can extend to days, weeks, months or even longer.

Moreover, even when such conventionally required manual registration of the various machines or components is completed, it is not uncommon that entities, including the aforementioned very high level personnel, have failed to properly assign the proper scopes and services to the various machines or components of the computing environment. Furthermore, in conventional security systems, it not uncommon to find such improper assignment of scopes and services to the various machines or components of the computing environment even after a conventional security system has been operational for years since its initial deployment. As a result, such improper assignment of the scopes and services to the various machines or components of the computing environment may have significantly and deleteriously impacted the security protection performance of conventional security systems even for a prolonged duration.

Furthermore, as stated above, most computing environments, including machine learning environments are not static. That is, various machines or components are constantly being added to, or removed from, the computing environment. As such changes are made to the computing environment, it is necessary to review the changed computing environment and once again assign the proper scopes and services to the various machines or components of the newly changed computing environment. Hence, the aforementioned overhead associated with the assignment of scopes and services to the various machines or components of the computing environment will not only occur at the initial phase when deploying a conventional security system, but such aforementioned overhead may also occur each time the computing environment is expanded, updated, or otherwise altered. This includes instances in which the computing environment is altered, for example, by is expanding, updating, or otherwise altering, for example, the roles of machine or components including, but not limited to, virtual machines of the computing environment.

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 shows an example computer system upon which embodiments of the present invention can be implemented, in accordance with an embodiment of the present invention.

FIG. 2 is a flow chart of steps performed by the present Component Awareness and Proximity Detection (CA-PD), in accordance with an embodiment of the present invention.

FIG. 3 is a schematic representation of a system in which a network and security system is configured with a Component Awareness and Proximity Detection, in accordance with an embodiment of the present invention.

FIG. 4 is a schematic representation of a system in which a network and security system is configured to receive results from a CA-PD module, integrated with the network and security system to determines Component Awareness and Proximity Detection, in accordance with an embodiment of the present invention.

FIG. 5 is a schematic representation of an embodiment of the Component Awareness and Proximity Detection module, in accordance with an embodiment of the present invention.

FIG. 6A is a diagram of an exemplary first degree of separation of Components, in accordance with an embodiment of the present invention.

FIG. 6B is a diagram of an exemplary second degree of separation of Components, in accordance with an embodiment of the present invention.

FIG. 6C is a diagram of an exemplary third degree of separation of Components, in accordance with an embodiment of the present invention

FIG. 6D is a diagram of an exemplary fourth degree of separation of Components, in accordance with an embodiment of the present invention

FIG. 7 is a diagram of an exemplary network topology, in accordance with an embodiment of the present invention

FIG. 8 is a schematic diagram of one embodiment of the Component Awareness and Proximity Detection module in accordance to the present invention

FIG. 9 is a schematic representation of a workflow (also referred to as a method of performance) of operations performed by the present novel component awareness module, in accordance with an embodiment of the present invention.

FIG. 10 is a schematic representation of a workflow (also referred to as a method of performance) of operations performed by the present novel host machine degree of separation module, in accordance with an embodiment of the present invention.

The drawings referred to in this description should not be understood as being drawn to scale except if specifically noted.

### DETAILED DESCRIPTION OF EMBODIMENTS

Reference will now be made in detail to various embodiments of the present technology, examples of which are illustrated in the accompanying drawings. While the present technology will be described in conjunction with these embodiments, it will be understood that they are not intended to limit the present technology to these embodiments. On the contrary, the present technology is intended to cover alternatives, modifications and equivalents, which may be included within the spirit and scope of the present technology as defined by the appended claims. Furthermore, in the following description of the present technology, numerous specific details are set forth in order to provide a thorough understanding of the present technology. In other instances, well-known methods, procedures, components, and circuits have not been described in detail as not to unnecessarily obscure aspects of the present technology.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “displaying”, “identifying”, “generating”, “deriving”, “providing,” “utilizing”, “determining,” or the like, refer to the actions and processes of an electronic computing device or system such as: a host processor, a processor, a memory, a virtual storage area network (VSAN), a virtualization management server or a virtual machine (VM), among others, of a virtualization infrastructure or a computer system of a distributed computing system, or the like, or a combination thereof. The electronic device manipulates and transforms data, represented as physical (electronic and/or magnetic) quantities within the electronic device's registers and memories, into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the Figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some embodiments, the functionality described herein may be provided within dedicated software modules or hardware modules configured as described herein. Also, the techniques could be fully implemented in one or more circuits or logic elements. A general-purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Example Computer System Environment

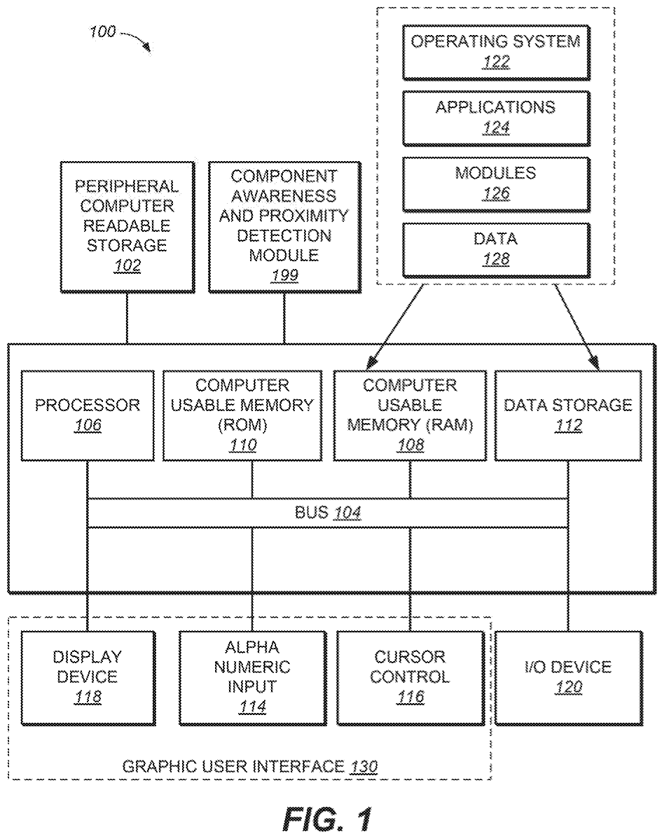

With reference now to FIG. 1, all or portions of some embodiments described herein are composed of computer-readable and computer-executable instructions that reside, for example, in computer-usable/computer-readable storage media of a computer system. That is, FIG. 1 illustrates one example of a type of computer (computer system 100) that can be used in accordance with or to implement various embodiments which are discussed herein. It is appreciated that computer system 100 of FIG. 1 is only an example and that embodiments as described herein can operate on or within a number of different computer systems including, but not limited to, general purpose networked computer systems, embedded computer systems, routers, switches, server devices, client devices, various intermediate devices/nodes, standalone computer systems, media centers, handheld computer systems, multi-media devices, virtual machines, virtualization management servers, and the like. Computer system 100 of FIG. 1 is well adapted to having peripheral tangible computer-readable storage media 102 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

System 100 of FIG. 1 includes an address/data bus 104 for communicating information, and a processor 106A coupled with bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, e.g., random access memory (RAM), coupled with bus 104 for storing information and instructions for processors 106A, 106B, and 106C. System 100 also includes computer usable non-volatile memory 110, e.g., read only memory (ROM), coupled with bus 104 for storing static information and instructions for processors 106A, 106B, and 106C. Also present in system 100 is a data storage unit 112 (e.g., a magnetic or optical disc and disc drive) coupled with bus 104 for storing information and instructions. System 100 also includes an alphanumeric input device 114 including alphanumeric and function keys coupled with bus 104 for communicating information and command selections to processor 106A or processors 106A, 106B, and 106C. System 100 also includes a cursor control device 116 coupled with bus 104 for communicating user input information and command selections to processor 106A or processors 106A, 106B, and 106C. In one embodiment, system 100 also includes a display device 118 coupled with bus 104 for displaying information.

Referring still to FIG. 1, display device 118 of FIG. 1 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 116 allows the computer user to dynamically signal the movement of a visible symbol (cursor) on a display screen of display device 118 and indicate user selections of selectable items displayed on display device 118. Many implementations of cursor control device 116 are known in the art including a trackball, mouse, touch pad, touch screen, joystick or special keys on alphanumeric input device 114 capable of signaling movement of a given direction or manner of displacement. Alternatively, it will be appreciated that a cursor can be directed and/or activated via input from alphanumeric input device 114 using special keys and key sequence commands. System 100 is also well suited to having a cursor directed by other means such as, for example, voice commands. In various embodiments, alpha-numeric input device 114, cursor control device 116, and display device 118, or any combination thereof (e.g., user interface selection devices), may collectively operate to provide a graphical user interface (GUI) 130 under the direction of a processor (e.g., processor 106A or processors 106A, 106B, and 106C). GUI 130 allows user to interact with system 100 through graphical representations presented on display device 118 by interacting with alpha-numeric input device 114 and/or cursor control device 116.

System 100 also includes an I/O device 120 for coupling system 100 with external entities. For example, in one embodiment, I/O device 120 is a modem for enabling wired or wireless communications between system 100 and an external network such as, but not limited to, the Internet.

Referring still to FIG. 1, various other components are depicted for system 100. Specifically, when present, an operating system 122, applications 124, modules 126, and data 128 are shown as typically residing in one or some combination of computer usable volatile memory 108 (e.g., RAM), computer usable non-volatile memory 110 (e.g., ROM), and data storage unit 112. In some embodiments, all or portions of various embodiments described herein are stored, for example, as an application 124 and/or module 126 in memory locations within RAM 108, computer-readable storage media within data storage unit 112, peripheral computer-readable storage media 102, and/or other tangible computer-readable storage media.

### Brief Overview

First, a brief overview of an embodiment of the present Component Awareness and Proximity Detection provisioning invention, is provided below. Various embodiments of the present invention provide a method and system for automated feature selection within a machine learning environment.

More specifically, the various embodiments of the present invention provide a novel approach for automatically providing an identification of computer resources and their physical residence for provisioning to logical components for the various machines or components of a computing environment such as, for example, machine learning environment. In one embodiment, an IT administrator (or other entity such as, but not limited to, a user/company/organization etc.) registers multiple number of machines or components, such as, for example, virtual machines onto a virtual computer system platform, such as, for example, the NSX™ platform from VMware, Inc. of Palo Alto. In the present embodiment, the IT administrator is not required to manually label all the virtual machines with the corresponding service type or indicate the importance of the particular machine or component. Further, the IT administrator is not required to selectively list only those machines or components which the IT administrator feels warrant protection from the security system platform. Instead, and as will be described below in detail, in various embodiments, the present invention, will automatically determine which machines or component are to be protected by the security system.

As will also be described below, in various embodiments, the present invention is a computing module which integrated within a virtual computing system such as, for example, the NSX™ platform of VMware, Inc. of Palo Alto. In various embodiments, the present invention provides a near neighbor identification methodology utilizing an automated “rack identification and awareness” methodology to map components and their respective hosts and, importantly, the particular rack location of the host, will itself figure out the service type and corresponding importance of various machines or components after observing the activity by each of the machines or components for a period of time.

Importantly, for purposes and brevity and clarity, the following detailed description of the various embodiments of the present invention, will be described using an example in which the embodiments of the present Component Awareness and Proximity Detection (CA-PD) invention are integrated into security system, such as, but not limited to, NSX™ platform from VMware, Inc. of Palo Alto, Calif. Importantly, although the description and examples herein refer to embodiments of the present invention applied to the above security system with, for example, its corresponding set of functions, it should be understood that the embodiments of the present invention are well suited to use with various other types of computer systems. Furthermore, although, for purposes of brevity and clarity, the present description and examples herein refer to NSX™ platform, it should be understood that the NSX™ platform 804 from VMware, Inc. of Palo Alto, Calif., may also be defined to include various other components, such as, but not limited to, an appliance module (NSX™ Appliance), and an NSX™ MP (management plane) component.

Additionally, for purposes of brevity and clarity, the present application will refer to “machines or components” of a computing environment. It should be noted that for purposes of the present application, the terms “machines or components” is intended to encompass physical (e.g., hardware and software based) computing machines, physical components (such as, for example, physical modules or portions of physical computing machines) which comprise such physical computing machines, aggregations or combination of various physical computing machines, aggregations or combinations or various physical and logical components and the like. Further, it should be noted that for purposes of the present application, the terms “machines or components” is also intended to encompass virtualized (e.g., virtual and software based) computing machines, virtual components (such as, for example, virtual modules or portions of virtual computing machines) which comprise such virtual computing machines, aggregations or combination of various virtual computing machines, aggregations or combinations or various virtual components and the like.

Additionally, for purposes of brevity and clarity, the present application will refer to machines or components of a computing environment. It should be noted that for purposes of the present application, the term “computing environment” is intended to encompass any computing environment (e.g., a plurality of coupled computing machines or components including, but not limited to, a networked plurality of computing devices, a neural network, a machine learning environment, and the like). Further, in the present application, the computing environment may be comprised of only physical computing machines, only virtualized computing machines, or, more likely, some combination of physical and virtualized computing machines.

Furthermore, again for purposes and brevity and clarity, the following description of the various embodiments of the present invention, will be described as integrated within a networking and security system. Importantly, although the description and examples herein refer to embodiments of the present invention integrated within a security system with, for example, its corresponding set of functions, it should be understood that the embodiments of the present invention are well suited to not being integrated into a security system and operating separately from a security system. Specifically, embodiments of the present invention can be integrated into a system other than a networking and security system. Embodiments of the present invention can operate as a stand-alone module without requiring integration into another system. In such an embodiment, results from the present invention regarding feature selection and/or the importance of various machines or components of a computing environment can then be provided as desired to a separate system or to an end user such as, for example, an IT administrator.

Importantly, the embodiments of the present component awareness and Proximity Detection (CA-PD) invention significantly extend what was previously possible with respect to providing component awareness, provisioning and security for machines or components of a computing environment. Various embodiments of the present component awareness and Proximity Detection (CA-PD) invention enable the improved capabilities while reducing reliance upon, for example, an IT administrator, to selectively register various machines or components of a computing environment for security protection and monitoring. This contrasts with conventional approaches for providing networking and security to various machines or components of a computing environment which highly dependent upon the skill and knowledge of a system administrator. Thus, embodiments of present component awareness and Proximity Detection identification (CA-PD) invention provide a methodology which extends well beyond what was previously known.

Also, although certain components are depicted in, for example, embodiments of the Component Awareness and Proximity Detection (CA-PD) invention, it should be understood that, for purposes of clarity and brevity, each of the components may themselves be comprised of numerous modules or macros which are not shown.

Procedures of the present Component Awareness and Proximity Detection (CA-PD) invention are performed in conjunction with various computer software and/or hardware components. It is appreciated that in some embodiments, the procedures may be performed in a different order than described above, and that some of the described procedures may not be performed, and/or that one or more additional procedures to those described may be performed. Further some procedures, in various embodiments, are carried out by one or more processors under the control of computer-readable and computer-executable instructions that are stored on non-transitory computer-readable storage media. It is further appreciated that one or more procedures of the present may be implemented in hardware, or a combination of hardware with firmware and/or software.

Hence, the embodiments of the present Component Awareness and Proximity Detection (CA-PD) invention greatly extend beyond conventional methods for providing security to machines or components of a computing environment. Moreover, embodiments of the present invention amount to significantly more than merely using a computer to provide conventional security measures to machines or components of a computing environment. Instead, embodiments of the present invention specifically recite a novel process, necessarily rooted in computer technology, for Component Awareness and Proximity Detection (CA-PD) invention.

Furthermore, in various embodiments of the present invention, and as will be described in detail below, a networking or security system, such as, but not limited to, the NSX platform or NSX™ platform from VMware, Inc. of Palo Alto, Calif. will include novel networking and security solution for a computing environment (including, but not limited to a data center comprising a virtual environment). In embodiments of the present invention, unlike conventional security systems which “chases the threats”, the present security system will instead focus on monitoring the intended states of applications, machines or components of the computing environment, and the present security system will raise alarms if any anomaly behavior is detected.

Additionally, as will be described in detail below, embodiments of the present invention provide a security system including a novel search feature for machines or components (including, but not limited to, virtual machines) of the computing environment. The novel search feature of the present network and security system enables ends users to readily assign the proper and scopes and services the machines or components of the computing environment, Moreover, the novel search feature of the present security system enables end users to identify various machines or components (including, but not limited to, virtual machines) similar to given and/or previously identified machines or components (including, but not limited to, virtual machines) when such machines or component satisfy a particular given criteria. Hence, as will be described in detail below, in embodiments of the present networking and security system, the novel search feature functions by finding or identifying the “siblings” of various other machines or components (including, but not limited to, virtual machines) within the computing environment.

### Continued Detailed Description of Embodiments after Brief Overview

As stated above, feature selection which is also known as “variable selection”, “attribute selection” and the like, is an import process of machine learning. The process of feature selection helps to determine which features are most relevant or important to use to create a machine learning model (predictive model).

In embodiments of the present invention, a networking and security system such as, for example, the NSX™ platform from VMware, Inc. of Palo Alto, Calif. will utilize a Component Awareness and Proximity Detection (CA-PD) module to automatically perform the feature selection process. That is, as will be described in detail below, in embodiments of the present Component Awareness and Proximity Detection (CA-PD) invention, a computing module, such as, for example, CA-PD module 199 of FIG. 1, is coupled with a computing environment. Additionally, it should be understood that in embodiments of the present Component Awareness and Proximity Detection (CA-PD) invention CA-PD module 199 of FIG. 1 may be integrated with one or more of the various components of FIG. 1. CA-PD module 199 then automatically evaluates the various machines or components of the computing environment to determine the importance of various features within the computing environment in order to optimally allocate components and resources in the computing environment in a way to reduce network latency while ensuring redundancy in the allocation of critical components to alleviate component failures in the computing environment.

Several selection methodologies are currently utilized in the art of feature selection. The common selection algorithms include three classes: Filter Methods, Wrapper Methods and Embedded Methods. In Filter Methods, scores are assigned to each feature based on a statistical measurement. The features are then ranked by their scores and are either selected to be kept as relevant features or they are deemed to not be relevant features and are removed from or not included in dataset of those features defined as relevant features. One of the most popular algorithms of the Filter Methods classification is the Chi Squared Test. Algorithms in the Wrapper Methods classification consider the selection of a set of features as a search result from the best combinations. One such example from the Wrapper Methods classification is called the “recursive feature elimination” algorithm. Finally, algorithms in the Embedded Methods classification learn features while the machine learning model is being created, instead of prior to the building of the model. Examples of Embedded Method algorithms include the “LASSO” algorithm and the “Elastic Net” algorithm.

Embodiments of the present Component Awareness and Proximity Detection (CA-PD) invention utilize a statistic model to determine the importance of a particular feature within, for example, a machine learning environment.

In an NSX or automated ML environment, this invention allows for intelligent communication between components. In one embodiment, kernel-to-kernel communication between co-located/co-hosted VMs, in contrast with conventional methods where communication is first routed through a distantly located network router and then ultimately back to a destination VM even when the source VM and the destination VM have closely located hosts (or even co-hosted by the same machine), allow communications to occur by reducing the number of physical devices the communication is routed through.

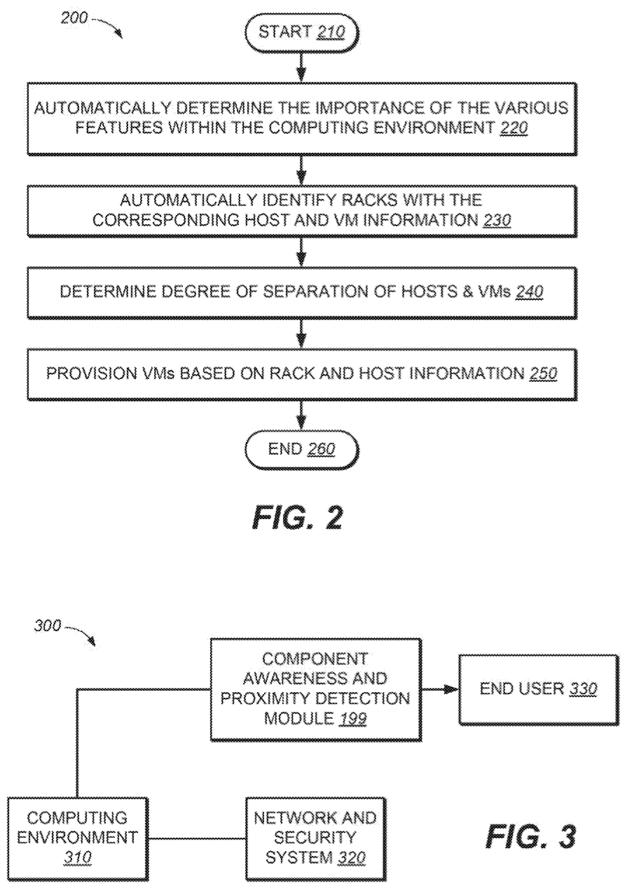

With reference now to FIG. 2, in embodiments of the present invention, the Component Awareness and Proximity Detection methodology within a machine learning environment is determined as follows. The component-to-host information is determined by fetching the information from data sources in the computing environment. In one embodiment, the present invention assumes the presence of pre-existing framework/platform like vRNI that follows a plugin/data-source architecture for fetching information from different sources and a central server for correlating the same.

Referring again to FIG. 2, in flow chart 200, as shown at 220, various embodiments of the present Component Awareness and Proximity Detection (CA-PD) invention examine the computing environment and identify the importance of various components and features within the computing environment. Embodiments of the present invention accomplish this task this by examining the computing environment and then determining the number of times a particular feature occurs within the computing environment as well as the communication pattern of the component.

With reference still to FIG. 2, as shown at 230, various embodiments of the present Component Awareness and Proximity Detection (CA-PD) invention again examine the computing environment and generates a VM and associating host machine information determine the value for (number machines providing the same type of service or communicating heavily between them). Embodiments of the present invention accomplish this task this by examining the machines within the computing environment and then determining which of the machines within the examined computing environment provide the same type of service and the communication pattern of the VMs.

Referring again to FIG. 2, at step 240, the degree of separation between the identified host machines is determine. This allows the Component Awareness and Proximity Detection module 199 to provision components and resources in such a way that critical components are not provisioned in the same host in the same rack at step 250.

With reference next to FIG. 3, a schematic diagram of a system 300 is provided. In FIG. 3, a computing environment 310 is coupled to the present CA-PD module 199. In the embodiment of FIG. 3, CA-PD module 199 is not integrated with networking and security system 320. In such an embodiment of the present Component Identification and Proximity Detection (CA-PD) invention, CA-PD module 199 operates as a stand-alone module without requiring integration into, for example, networking and security system 320. In one such embodiment, results from the present Component Identification and Proximity Detection (CA-PD) invention, regarding component identification and feature selection and/or the importance of various machines or components of a computing environment, are provided, for example, to a separate system or to an end user such as, for example, end user 330. In one such embodiment, end user 330 will, for example, use the results from CA-PD module 199 to manually assign the appropriate provisioning/unprovisioning and security protection and monitoring (which is then applied, for example, by a security system such as, for example, security system 330) corresponding to the importance of various machines or components of computing environment 310.

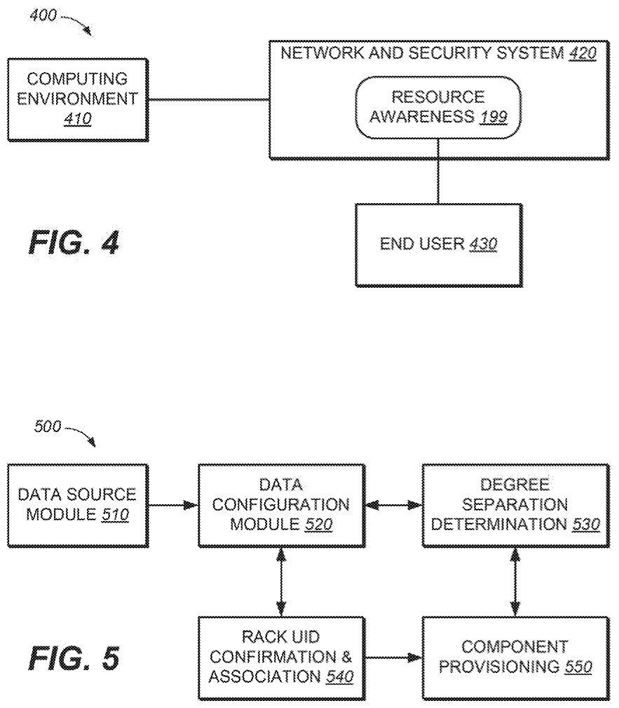

With reference now to FIG. 4, a schematic diagram of a system 400 is provided. In FIG. 4, a computing environment 410 is coupled to the present CA-PD module 199. In the embodiment of FIG. 4, CA-PD module 199 is integrated with networking and security system 420 such as, for example, the NSX™ platform of VMware, Inc developed by VMware, Inc. of Palo Alto, Calif. In such an embodiment of the present Component Awareness and Proximity Detection (CA-PD) invention, CA-PD module 199 operates as an integrated portion of, for example, system 420. In one such embodiment, results from the present Component Awareness and Proximity Detection (CA-PD) invention, regarding feature selection and/or the importance of various machines or components of a computing environment, are automatically provided to system or to an end user such as, for example, end user 430.

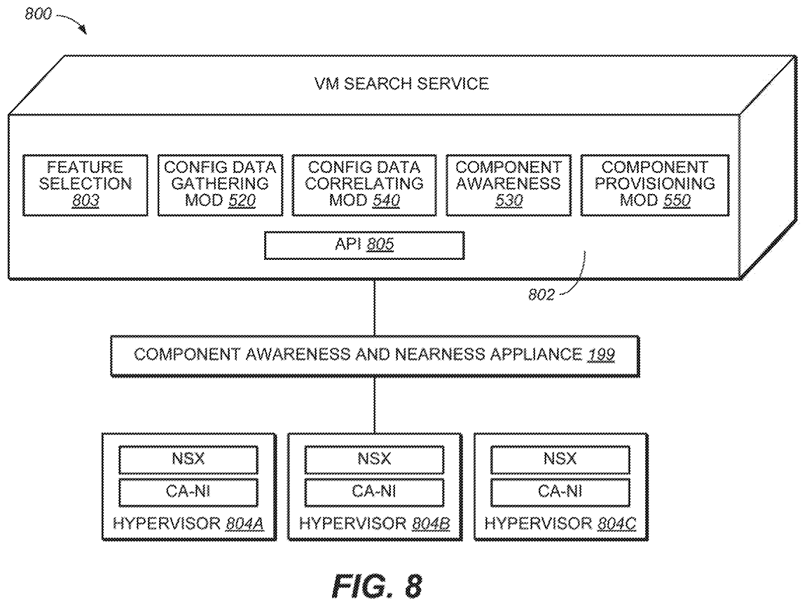

In one such embodiment, end user 430 will, for example, use the results from CA-PD module 199 to manually assign the appropriate network or security protection and monitoring (which is then applied, for example, by a network and security system such as, for example, system 420) corresponding to the importance of various machines or components of computing environment 410. In one embodiment, the operations of present Component Awareness and Proximity Detection (CA-PD) invention are performed, for example, by feature selection module 803 of FIG. 8.

Referring still to FIG. 4, in another embodiment of the present Component Awareness and Proximity Detection (CA-PD) invention, CA-PD module 199 again operates as an integrated portion of, for example, system 430. In one such embodiment, results from the present Component Awareness and Proximity Detection (CA-PD) invention, regarding feature selection and/or the importance of various machines or components of a computing environment, are automatically provided to system 420 without requiring any intervention by an end user (such as end user 430). In one such embodiment, system 420, will automatically use the results from CA-PD module 199 and automatically and autonomously assign the appropriate networking and security protection and monitoring to the various machines or components of computing environment 410 as necessitated by the corresponding importance of the various machines or components of computing environment 410.

Importantly, the embodiments of the present Component Awareness and Proximity Detection (CA-PD) invention significantly extend what was previously possible with respect to providing network security for machines or components of a computing environment. Various embodiments of the present Component Awareness and Proximity Detection (CA-PD) invention enable the improved capabilities while reducing reliance upon, for example, an IT administrator, to selectively register various machines or components of a computing environment for security protection and monitoring. This contrasts with conventional approaches for providing security to various machines or components of a computing environment which highly dependent upon the skill and knowledge of a system administrator.

Furthermore, embodiments of the present Component Awareness and Proximity Detection (CA-PD) invention utilize a novel feature selection methodology, including the resource identification and degrees of separation analysis, for feature selection and importance determination for features and corresponding machines or components of a computing environment. Even further, embodiments of the present Component Awareness and Proximity Detection (CA-PD) invention utilize the above-mentioned novel feature identification and selection methodology in an automated manner and then various embodiments also automatically (e.g., without requiring intervention of an IT administrator) apply, via a networking and security system, appropriate monitoring and protection to the various features (and corresponding machines or components) of the computer environment. Thus, embodiments of present Component Awareness and Proximity Detection (CA-PD) invention provide a methodology which greatly and non-obviously extends well beyond what was previously known.

Hence, the embodiments of the present Component Awareness and Proximity Detection (CA-PD) invention greatly extend beyond conventional methods for performing feature selection within a computing environment. Moreover, embodiments of the present invention amount to significantly more than merely using a computer to provide conventional security measures to machines or components of a computing environment. Instead, embodiments of the present invention specifically recite a novel process, necessarily rooted in computer technology, for automated Component Awareness and Proximity Detection (CA-PD).

Additionally, embodiments of the present Component Awareness and Proximity Detection (CA-PD) invention greatly extend beyond conventional methods for providing security to machines or components of a computing environment. That is, embodiments of the present invention amount to significantly more than merely using a computer to provide conventional networking and security measures to machines or components of a computing environment. Instead, embodiments of the present invention specifically recite a novel process, necessarily rooted in computer technology, for automated identification of components with their corresponding host and their degree of separation from each other, and then using the results to automatically assign appropriate provisioning/unprovisioning measures to the various machines or components of a computing environment.

In various embodiments, the present Component Awareness and Proximity Detection (CA-PD) invention automatically provides feature selection information. In so doing, the present embodiments enable improved security monitoring for the various machines or components of a computing environment. Thus, embodiments of the present invention teach novel approaches for using a computer to overcome a problem specifically arising in the computer-based realm of providing network access and security to various machines or components of a computing environment, such as, for example, a machine learning environment.

With reference now to FIG. 5, an embodiment of the Component Awareness and Proximity Detection module 199 in accordance to the present invention is provided. As depicted in FIG. 5, in one embodiment, the present Component Awareness and Proximity Detection module 199 comprises data source module 510, a data configuration module 520, a rack identification and association module 530, a host degree of separation module 540 and a component provisioning module 550. In one embodiment, the present component awareness and Proximity Detection invention assumes a pre-existing framework/platform like vRNI that follows a plugin/data-source architecture for fetching information.

Referring still for FIG. 5, in one embodiment, data source 510 gets rack, enclosure and blade/chassis information from a DCIM/CI using REST/CLI/SDK. This information contains the unique identifiers for the rack and/or enclosures along with the network interface information like the MAC address. Data configuration module 520 collects configuration data from vCenter about all existing hosts and their pnics. In one embodiment, if the MAC address of a pnic of a host matches the MAC address of the network interface of a blade/chassis the Component Awareness and Proximity Detection module 199 concludes that a particular host is installed on that blade/chassis and then correlates the rack/enclosure ID with the host and all VMs running on the host at module 530. This information is then maintained as labels or annotations on the host in the vCenter configuration or in a separate database. The Degree separation determination module 540 takes the VM information from module 530 and determines the degree of separation of the hosts identified to determine how to provision the VMs in the computing environment by module 550.

Referring still to FIG. 5, in another embodiments of the present component awareness and Proximity Detection invention, in addition to identifying the machines or components (including, but not limited to virtual machines) of the computing environment, the present Component Awareness and Proximity Detection may be implemented in a non-DCIM or Converged infrastructure environment. In such an environment, vCenter and physical routers, switches are added to vRNI as data sources. In this embodiment, CDP/LLDP information from hardware switches are used to find all hosts connected to them. In this embodiment, the switch identifier is used as the rack identifier for a host. If a host is connected to more than one distinct physical switch, then the identifier of all switches is combined in a pre-determined order (e.g., sorted alphabetically) to derive the rack identifier system (as will be described in detail below) will also provide the user with information regarding machines or components of the computing environment which have similar scores and/or reasonings. In so doing, and as will be described in detail below, embodiments of the present network and security system also enable users to select those machines or components of the computing environment which have similar scores and/or reasonings and thereby assign such machines or components of the computing environment to the particular service.

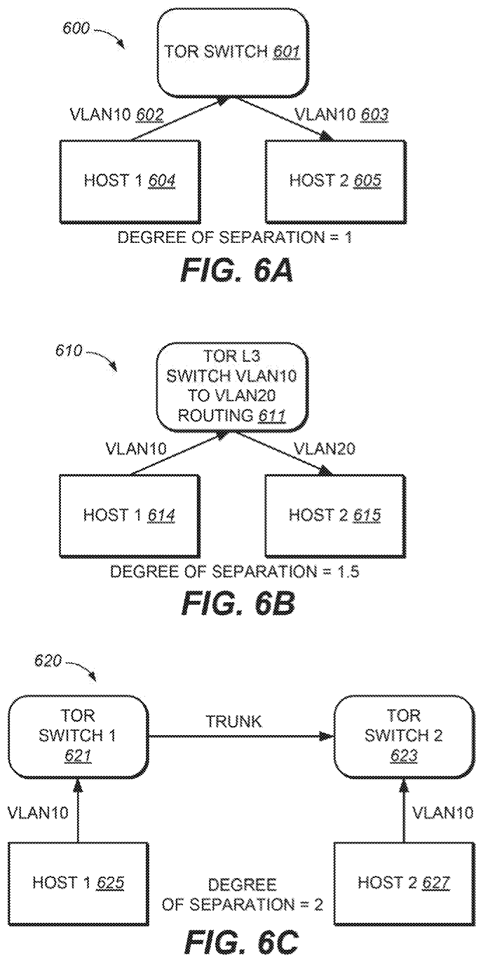

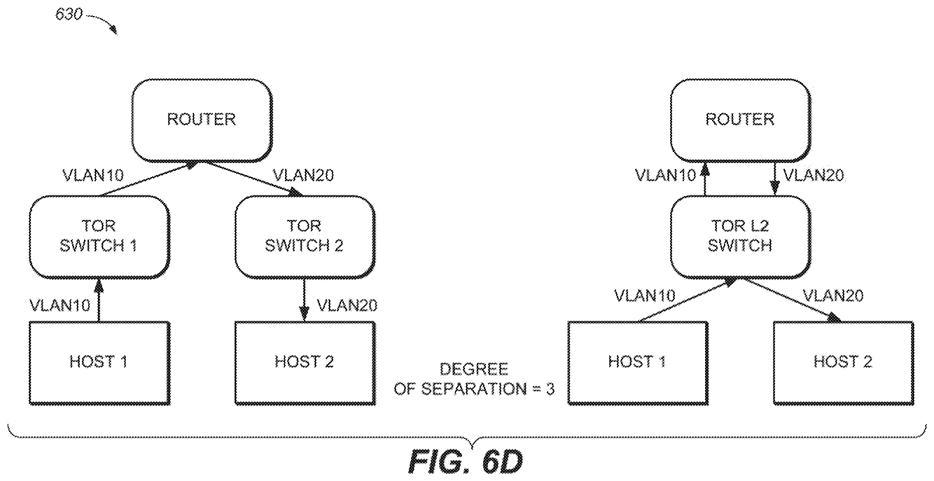

Referring now to FIG. 6A through FIG. 6D of exemplary embodiments of the host degree of separation for host machines in the computing environment utilized by the present invention. Near-by-hosts is defined as the degree of L2 & L3 separation between host. The degree of separation determines how may physical devices a host must go through to communicate with another host. In FIG. 6A, the hosts 604-605 are on the same L2 602-603 and connected to the same physical switch 601 are “nearest” to each other. In this instance the degree of separation is 1. In FIG. 6B, the host 614-615 are on different L2s 612-613 but on the same physical switch 611 (e.g., it could be a L3 switch with VREs and L2 bridging capability) the degree of separation between the host 614-615 in this case will be 1.5.

Referring still to FIG. 6A-6D, in FIG. 6C, the hosts 622, 624 are on the same L2 621, 623 but different physical switches 621, 623 connected by trunks 626. In this example, the degree of separation is 2. In FIG. 6D, two different configurations are illustrated. In the first configuration, the hosts 638, 639 are located on different L2s 637, 638 and the same of different physical switches 634, 635 and routed via the same physical router 631. In this configuration the degree of separation is 3. In the second configuration in FIG. 6D, the hosts 646, 647 are different L2s 644, 645 that are connected to the same switch 643. Switch 643 connects to the same router 640. In the second configuration, the degree of separation is also 3.

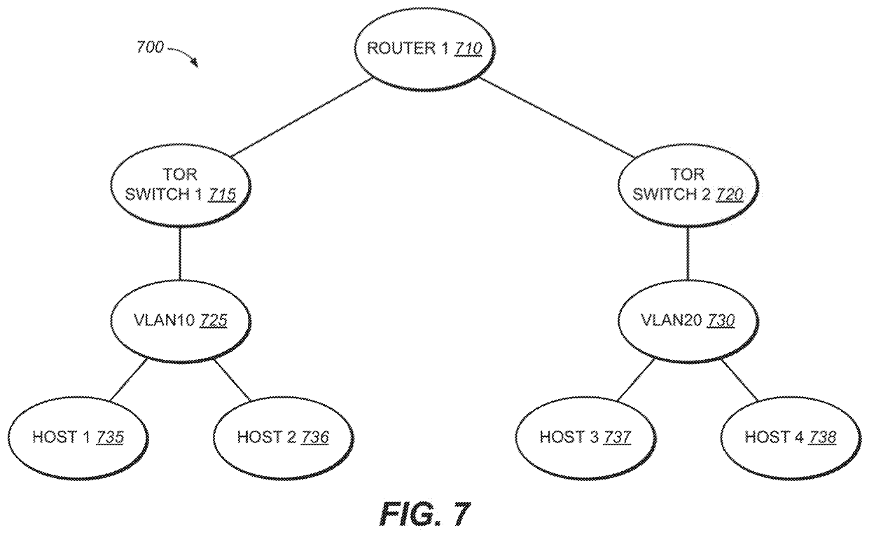

Referring now to FIG. 7, a diagram illustrating the network topology map after the implementation of one embodiment of the Component Awareness and Proximity Detection in the computing environment in accordance to the present invention, is shown. In one embodiment of the component awareness and Proximity Detection identification implementation using CDP/LLDP information from switches and vCenter, along with the subnet and/or Virtual Local Area Network (VLAN) information from the switches and vCenter, a graph of the L2,L3, ports, VLANs and hots in the computing environment is generated as shown in the network topology graph in shown in FIG. 7. As shown in FIG. 7, the hosts 735,736,737,738 are on different L2s 725,730. The L2s are connected to different Top Of Rack (TOR) switches 715,720 which both are connected to the same router 710. The graph shown in FIG. 7 is traversed with graph traversal algorithms to determine the degree of separation between a given pair of hosts. Given a host and a required degree of separation, other hosts in the computing environment that satisfy the criteria are also identified.

Referring now to FIG. 8, a schematic diagram 800 of an embodiment of the present invention integrated with a network and security system is provided. As will be discussed below, it should be noted that in various embodiments, novel aspects of the present network and security system may be integrated into a complete network and security system. In various other embodiments, novel aspects of the present network and security system may exist as a separate component or module. In one such embodiment, the separate component or module will operate, for example, as a server, which runs independently from the main component of, for example, a legacy or conventional network and security system.

With reference still to FIG. 8, in various embodiments of the present invention, at the backend of schematic diagram 800, novel aspects of the present invention such as, for example, a VM search module runs as a server independently from the main component of a network and security system such as, but not limited to, the NSX™ platform 804 of VMware, Inc developed by VMware, Inc. of Palo Alto, Calif.

In such an embodiment, the novel aspects of the present invention run independently from the main component of a network and security system because the novel component, such as the VM search module 802 (also referred to as a VM Search Service) uses Machine Learning (ML) techniques which heavily rely on data processing, data mining and advanced computations such as matrix operations.

Hence, the computational requirements of the VM search module 802 are quite different from the computational requirements of the overall security system such as, but not limited to, the NSX™ platform 804 of VMware, Inc developed by VMware, Inc. of Palo Alto, Calif. It should be noted that for purposes of brevity and clarity, the abbreviation VM is used herein to refer to the term “virtual machine”. It should be noted, however, that the various embodiments of the present invention are not limited solely to use with virtual machines, but, instead, the various embodiments of the present invention are well suited to use with various other machines or components (including, but not limited to, virtual machines) within a computing environment.

Additionally, in various embodiments of the present invention, by having the novel aspects of the present invention run independently from the main component of a network and security system, embodiments of the present invention enable engineers working on the novel VM search module 802 to have different skill sets than the skill sets of the traditional application developers who typically work on conventional security systems. As yet another advantage of embodiments of the present invention, in which the novel VM search module 802 runs separately from the network and security system, the separately operating novel VM search module 802 has reduced interference with the functions of the conventional network and security system.

Referring still to FIG. 8, in one embodiment, the present VM search module 802 sits on an individual web server such as, but not limited to, for example, an AWS Elastic Beanstalk™ web server of Amazon.com, Inc of Seattle, Wash. In one such embodiment as depicted in FIG. 8, novel aspects of the present invention are located in the same virtual private cloud (VPC) network as the management plane of the conventional security system (for example, but not limited to, the management plane (MP) of the NSX™ platform 804A-804C of VMware, Inc developed by VMware, Inc. of Palo Alto, Calif. As a result, in various embodiments of the present invention, novel aspects of the present security system, such as the VM search module are able to readily access the relational database service of the conventional network and security system. Furthermore, in such an embodiment of the present invention, the CA-PD can also access the application program interfaces (APIs) 805 provided by the present VM search module 802.

With reference still to FIG. 8, embodiments of the present invention also install an agent on each hypervisor 804A-804C. In such an embodiment, the agent collects data pertaining to, for example, process information, network ports, and the like, from the data plane, and the agent then uploads the data to a relational database service on the web server.

Referring still to the FIG. 8, in various embodiments of the present invention, the VM search module 802 also requests data from the computing environment and uses a CA-PD awareness and Proximity Detection feature selection analysis to determine the critical features of every scope and service. In various embodiments, the present CA-PD feature selection analysis is performed, for example, by component awareness module 530 of FIG. 8. Furthermore, in various embodiments, component module 530 comprises a portion of VM search module 802. The CA-PD awareness and Proximity Detection feature analysis is described in detail above in conjunction with the discussion of FIG. 1 through FIG. 10.

In various embodiments of the present invention, the CA-PD feature selection analysis is directly used to find VMs matching a given host. To find VMs for a given service, the present CA-PD feature selection analysis is extended.

In various embodiments of the present invention, after the above-described CA-PD feature selection and analysis, the novel VM search module 802 of the present embodiment computes the weight score for each feature accordingly to the CA-PD feature selection and analysis, and saves the results in the local machine learning (ML) database. Also, in some embodiments, the above-mentioned local machine learning (ML) database is comprised, for example, of ML non-relational database (DB) of FIG. 8. Furthermore, in various embodiments, ML non-relational database (DB), which receives results, comprises a portion of novel VM search module 802. Additionally, as described above in conjunction with the discussion of FIGS. 1-10, in various embodiments of the present invention, the results derived from the present Component Awareness and Proximity Detection selection analysis are periodically updated.

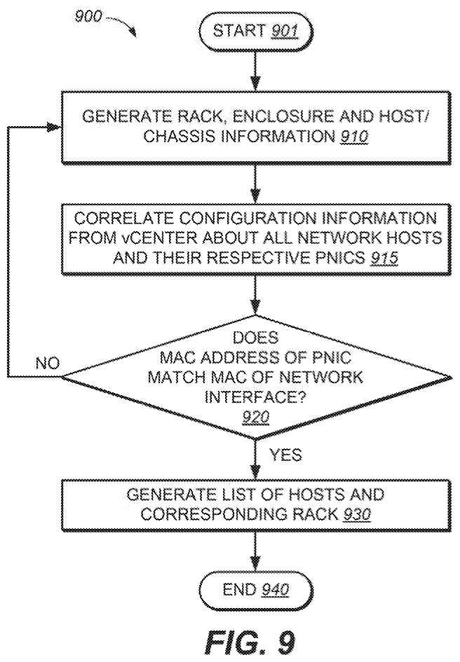

With reference now to FIG. 9, a schematic representation of a workflow 900 (also referred to as a method of performance) of operations performed by an embodiment of the present novel component identification module 199 is provided. It should be noted that although the operations of workflow 900 are depicted in a certain order in FIG. 9, embodiments of the present invention may perform the various operations in an order which differs from the order of workflow 900. Additionally, in various embodiments of the present inventions, various operations may be added to workflow 900, and various of the operations in workflow 900 may be omitted.

Still referring to workflow 900 of FIG. 9, at 910, in one embodiment of the present invention, a search request is sent to the present novel Component Awareness and Proximity Detection module 199. Additionally, in various embodiments of the present invention, at 910, the search request will include a request to generate existing network device configuration information including the rack identification (rack id), enclosure and host/chassis information.

At 915 of workflow 900, the present novel Component Awareness and Proximity Detection module 199 correlates the configuration information from vCenter about all network hosts and their respective physical network adapter in the server (pnics), The configuration information is presented to workflow 900. At 920 the Media Access Control (MAC) address of the pnic is compared against the MAC address of the network interface to confirm if the request is valid.

If the request is valid a list of hosts and their corresponding rack information is generated. If the request is invalid the present novel Component search module 802 returns to 910 to regenerate the rack/enclosure information, as well as the host/chassis information in the computing environment. as shown at 910, to, for example, a graphic user interface used by the user to submit the search request.

At 930 of workflow 900, the present novel VM search module 802 will utilize, for example, ML non-relational database (DB) to find all the classified machines or components (e.g., but not limited to, virtual machines (VMs)) in the computing environment and generates a list of all host servers and their associated rack information.

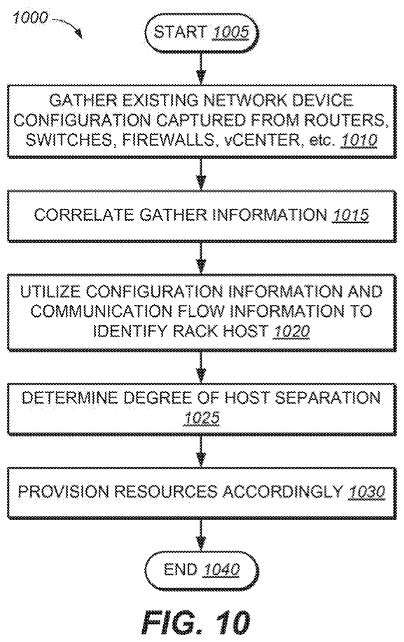

With reference now to FIG. 10, a schematic representation 1000 of workflow performed by the degree separation module 530 of one embodiment of the present invention. As shown in FIG. 10, the degree separation module 530 gathers existing network device information at step 1010. In addition to this, the degree separation module 530 gathers configuration information from the computing environment, such as router, switches, firewalls information. In one embodiment, this information can be gathered from the vCenter device configuration table.

At step 1015, the degree separation module 530 correlates the configuration data gathered in step 1010 to generate a graph of components with their corresponding rack information.

At step 1020, the configuration information with the associated communication flow information is used to identify the rack-host maps in the computing environment. With this mapping, the degree of separation between hosts is generated at step 1025 to allow the provisioning of components in the computing environment. In one embodiment, critical components are provisioned at step 1030 in such a way to ensure that they do not reside in the physical location. By ensuring that the degree of separation between hosts in the computing environment are mitigated to a reasonably low number, the present invention reduces network latency, reduce loads on communication networks, and increase communication and operation efficiency.

Hence, embodiments of the present invention greatly extend beyond conventional methods for providing security to machines or components of a computing environment. Moreover, embodiments of the present invention amount to significantly more than merely using a computer to provide conventional security measures to machines or components of a computing environment. Instead, embodiments of the present invention specifically recite a novel process, necessarily rooted in computer technology, for providing security to machines or components of a computing environment.

Furthermore, in various embodiments of the present invention, a security system, such as, but not limited to, the NSX™ platform 804 from VMware, Inc. of Palo Alto, Calif. will include a novel security solution for a computing environment (including, but not limited to a data center comprising a virtual environment). In embodiments of the present invention, unlike conventional security systems which “chases the threats”, the present security system focuses on monitoring the intended states of applications, machines or components of the computing environment, and the present security system will raise alarms if any anomaly behavior is detected.

Additionally, embodiments of the present invention provide a security system including a novel search feature for machines or components (including, but not limited to, virtual machines) of the computing environment. The novel search feature of the present security system enables ends users to readily assign the proper and scopes and services the machines or components of the computing environment, Moreover, the novel search feature of the present security system enables end users to identify various machines or components (including, but not limited to, virtual machines) similar to given and/or previously identified machines or components (including, but not limited to, virtual machines) when such machines or component satisfy a particular given criteria. Hence, in embodiments of the present network and security system, the novel search feature functions by finding or identifying the “siblings” of various other machines or components (including, but not limited to, virtual machines) within the computing environment.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the Claims.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A computer-implemented method for automated component awareness and proximity detection in a computing environment, said method comprising:
automatically monitoring components of said computing environment;
performing a feature selection analysis of said components of said computing environment;
generating unique identifiers to uniquely identify physical components in said computing environment;
generating a list of host servers residing in said uniquely identified physical components;
determining communication flow between logical components residing in said host servers to determine similarities between said logical components;
associating said logical components with said host servers in said physical components to track communications between said logical components in said computing environment to optimize network latency; and
providing results of said method for automated analysis of said features of said logical components of said computing environment.

2. The computer-implemented method of claim 1, wherein said associating said logical components with said host servers further comprises:
co-hosting said logical components to ensure that critical logical components are not provisioned in the same said host servers in said computing environment.

3. The computer-implemented method of claim 1, wherein said provisioning said logical components, comprises determining the degree of separation between communicating components utilized by said logical components in said computing environment

4. The computer-implemented method of claim 3, wherein said determining said degree of separation further comprises routing communications between said critical components using a minimum number of said communication components in order to reduce network latency in said computing environment.

5. The computer-implemented method of claim 4, wherein said determining said degree of separation further comprises determining a number of logical communication components degree of separation between said communicating pair of said logical components of said computing environment

6. The computer-implemented method of claim 1, wherein said determining said degree of separation further comprises co-hosting components in the computing environment to avoid communicating latency between said co-hosted components.

7. The computer-implemented method of claim 6, wherein said co-hosting components comprises hosting said components to ensure redundancy in the locating of critical components in order to avoid component failures in said computing environment.

8. The computer-implemented method of claim 6, further comprising:
periodically repeating said automated monitoring of said physical components in said computing environment to generate updated results of said automated monitoring of said physical components of said computing environment.

9. The computer-implemented method of claim 1, wherein said physical component comprises server racks.

10. The computer-implemented method of claim 1, further comprising:
periodically repeating said automated analysis of component features in said computing environment to generate updated results of said automated analysis of said component features of said components of said computing environment.

11. The computer-implemented method of claim 10, further comprising:
providing said updated results of said automated analysis of said component features of said components of said computing environment to a network and security system.

12. The computer-implemented method of claim 1, further comprising:
automatically providing said results for said automated analysis of said component features of said components of said computing environment without requiring intervention by a system administrator.

13. A computer-implemented method for automatically identify computing components and their proximity to each other in a computing environment, said method comprising:
automatically monitoring physical components of said computing environment;
generating configuration information of said physical components;
generating a list of host servers associated with said physical components;
generating logical components residing in said host servers; and
provisioning said logical components based on said host servers and said physical component information to avoid having critical logical components residing in the same host server in said physical component.

14. The computer-implemented method of claim 13, wherein said physical component comprises server racks.

15. The computer-implemented method of claim 13, wherein said provisioning said logical components, comprises determining the degree of separation between communicating components utilized by said logical components in said computing environment.

16. The computer-implemented method of claim 13, wherein said determining said degree of separation further comprises routing communications between said critical components using a minimum number of said communication components in order to reduce network latency in said computing environment.

17. The computer-implemented method of claim 16, wherein said determining said degree of separation further comprises determining a number of logical communication components degree of separation between said communicating pair of said logical components of said computing environment.

18. The computer-implemented method of claim 16, wherein said determining said degree of separation further comprises co-hosting components in the computing environment to avoid communicating latency between said co-hosted components.

19. The computer-implemented method of claim 18, wherein said co-hosting components comprises hosting said components to ensure redundancy in the locating of critical components in order to avoid component failures in said computing environment.

20. The computer-implemented method of claim 13, further comprising:
periodically repeating said automated monitoring of said physical components in said computing environment to generate updated results of said automated monitoring of said physical components of said computing environment.
